(19) United States
(12) Patent Application Publication
(10) Pub. No.: US 2025/0305428 A1
(43) Pub. Date: Oct. 2, 2025

(54) Advanced Valve Train Assembly for Engine Brake and Cylinder Deactivation

(71) Applicant: Eaton Intelligent Power Limited, Dublin (IE)

(72) Inventors: Jan Kindermann, Prague (CZ); Andrei Dan Radulescu, Marshall, MI (US)

(21) Appl. No.: 19/236,836

(22) Filed: Jun. 12, 2025

Related U.S. Application Data
(63) Continuation of application No. PCT/EP2023/025552, filed on Dec. 21, 2023.
(60) Provisional application No. 63/476,758, filed on Dec. 22, 2022.

(51) Int. Cl. F01L 13/06; F01L 1/18; F01L 1/46; F02D 13/04

(52) U.S. Cl. CPC F01L 13/06; F01L 1/18; F01L 1/46; F02D 13/04

(57) ABSTRACT

In one embodiment, a valve train assembly includes a rocker arm having a cam end in proximity to a cam and a valve end opposite to the cam end and in proximity to one or more valves, an engine brake capsule coupled to the cam end, and a cylinder deactivation capsule coupled to the cam end. The engine brake capsule includes an actuation pin assembly, a check valve assembly, and a plunger, and is configured to switch between a retracted position and an extended position. The cylinder deactivation capsule includes an outer body, an inner body, and a latching mechanism, and is configured to switch between a latched position and an unlatched position. In this way, the valve train assembly may perform both engine brake and cylinder deactivation functionalities, for example, at the cam side of the valve train assembly.

### CROSS REFERENCE TO RELATED APPLICATION

This application claims the benefit under 35 U.S.C. § 365(c) of International Patent Application No. PCT/EP2023/025552, filed 21 Dec. 2023, which claims the benefit under 35 U.S.C. § 119(e) of U.S. Provisional Patent Application No. 63/476,758, filed 22 Dec. 2022, which are incorporated herein by reference.

### TECHNICAL FIELD

This disclosure relates generally to a valve train system, and more particularly to an advanced valve train assembly for engine brake and cylinder deactivation (CDA).

### BACKGROUND

Internal combustion engines typically use valve train systems to actuate engine valves. For example, these systems may include a combination of cams, shafts, rocker arms, and various motion-conveying mechanisms that may be driven by the engine's crankshaft rotation, selectively conveying actuation motion to the downstream valves.

### SUMMARY OF PARTICULAR EMBODIMENTS

This disclosure presents a valve train assembly that enables both engine brake and CDA functionalities. For example, by arranging the engine brake and CDA components on a cam side of a rocker arm, particular embodiments may provide a number of benefits including but not limited to reduced packaging space, simplified engine assembly, and improved dynamic behavior, just to name a few.

In one embodiment, a valve train assembly includes a rocker arm having a cam end in proximity to a cam and a valve end opposite to the cam end and in proximity to one or more valves, an engine brake capsule coupled to the cam end of the rocker arm, and a cylinder deactivation capsule coupled to the cam end of the rocker arm. In particular, the engine brake capsule includes an actuation pin assembly, a check valve assembly, and a plunger. The engine brake capsule is configured to switch between a retracted position and an extended position. In particular, the cylinder deactivation capsule includes an outer body, an inner body, and a latching mechanism. The cylinder deactivation capsule is configured to switch between a latched position and an unlatched position.

In particular embodiment, when the engine brake capsule is configured to switch to the extended position and the cylinder deactivation capsule is configured to switch to the latched position, the rocker arm is allowed to be actuated based on a brake lift profile of the cam. In particular embodiment, when the engine brake capsule is configured to switch to the retracted position and the cylinder deactivation capsule is configured to switch to the latched position, the rocker arm is allowed to be actuated based on a main lift profile of the cam. In particular embodiment, when the cylinder deactivation capsule is configured to switch to the unlatched position, the rocker arm is unactuated despite rotation of the cam.

In particular embodiment, the cylinder deactivation capsule is directly coupled to the engine brake capsule. In particular embodiment, the cylinder deactivation capsule is coupled to the engine brake capsule via a push rod. In particular embodiment, the cylinder deactivation capsule is coupled to the engine brake capsule, and the engine brake capsule is coupled to the cam end of the rocker arm via a push rod. In particular embodiment, the cylinder deactivation capsule is coupled to the engine brake capsule, and the cylinder deactivation capsule is coupled to the cam end of the rocker arm via a push rod.

In particular embodiment, the engine brake capsule is at least partially embedded in the cam end of the rocker arm. In particular embodiment, the cylinder deactivation capsule is at least partially embedded in the cam end of the rocker arm.

In particular embodiment, the check valve assembly comprises a ball and a valve spring. In particular embodiment, the valve spring is configured to bias the ball upward to close an opening in the engine brake capsule.

In particular embodiment, in the retracted position of the engine brake capsule, the plunger is configured to be retractable relative to the cam end to absorb a brake lift profile of the cam. In particular embodiment, in the extended position of the engine brake capsule, the plunger is configured to remain extended relative to the cam end to transmit motion applied by a brake lift profile of the cam.

In particular embodiment, an upper end of the plunger is configured with a shim.

In particular embodiment, the latching mechanism comprises one or more latch pins and a spring.

In particular embodiment, in the unlatched position of the cylinder deactivation capsule, the cylinder deactivation capsule is configured to absorb motion applied by the cam. In particular embodiment, in the latched position of the cylinder deactivation capsule, the cylinder deactivation capsule is configured to allow motion applied by the cam to be transferred to the plunger of the engine brake capsule.

In particular embodiment, the valve train assembly further includes a carrier assembly to support the rocker arm. In particular embodiment, the carrier assembly includes a plurality of carriers for supporting the rocker arm, a base plate for supporting the plurality of carriers, and a fluid inlet in fluid communication with the base plate.

### BRIEF DESCRIPTION OF THE DRAWINGS

Embodiments in accordance with this disclosure will now be described by reference to the accompanying drawings, in which:

FIG. 1 illustrates an example valve train assembly according to one embodiment of this disclosure;

FIG. 2 illustrates a cross-sectional view of an example rocker arm according to one embodiment of this disclosure, specifically showing an engine brake capsule of the rocker arm;

FIG. 3 illustrates an example switching process of the engine brake capsule of FIG. 2;

FIG. 4 further illustrates the engine brake capsule;

FIG. 5 illustrates an example CDA capsule of a lifter assembly according to one embodiment of this disclosure;

FIGS. 6A-6C illustrate an example carrier assembly according to one embodiment of this disclosure, which may be used in connection with a valve train assembly;

FIG. 7 illustrates an example valve train assembly according to another embodiment of this disclosure;

FIG. 8 illustrates an example CDA capsule of a lifter assembly of the valve train assembly of FIG. 7;

FIG. 9 illustrates an example valve train assembly according to yet another embodiment of this disclosure; and

FIG. 10 illustrates a cross-sectional view of an engine brake capsule of the valve train assembly of FIG. 9.

### DESCRIPTION OF EXAMPLE EMBODIMENTS

Reference will now be made in detail to the examples which are illustrated in the accompanying drawings. Wherever possible, the same reference numbers will be used throughout the drawings to refer to the same or like parts. Directional references such as “up”, “down”, “right”, and “left” are for ease of reference to the figures and not intended to limit the scope of this disclosure.

The embodiments disclosed herein present a combined solution for engine braking and CDA functionalities, which may be useful for example in the exhaust part of an advanced valve train system. As an example and not by way of limitation, one example valve train may be a type V valve train (for example, in a type V valve train, the system may include a push rod to transfer actuation motion from a cam to the rocker arm,) although other suitable valve train configurations are also envisioned by this disclosure. Apart from standard lift for main exhaust operation, particular designs disclosed herein may deliver engine brake function in combination with CDA function.

In particular embodiments, by having both engine brake and CDA delivering components on a cam side of the rocker arm, the overall system may be improved, saving a significant amount of space, for example, close to a valve bridge as compared to conventional engine brake systems. This may be beneficial in engine designs with limited space around the valve bridges. In particular embodiments, there may be several alternative ways to design the system. For example, the engine brake function may be delivered by an engine brake capsule (e.g., via hydraulics or mechanically or other suitable ways) that is positioned on the cam side of the rocker arm, engine brake capsule, details of which will be explained below. The CDA function may be delivered by a CDA capsule (e.g., via hydraulics or mechanically or other suitable ways) that is also positioned on the cam side of the rocker arm, details of which will be explained below. For example, the placement of the engine brake capsule and the CDA capsule may vary across embodiments, As an example, in certain embodiments, the engine brake capsule may be positioned or embedded in the cam end of the rocker arm and may be coupled to the CDA capsule via a push rod. In this case, the CDA capsule may contact the cam. As another example, in certain embodiments, the CDA capsule may be positioned or embedded in the cam end of the rocker arm and may be coupled to the engine brake capsule via a push rod. In this case, the engine brake capsule may contact the cam. As a further example, in certain embodiments, the engine brake capsule may be connected to the CDA capsule, which may be connected to the rocker arm via a push rod. In this case, the engine brake capsule may contact the cam. Alternatively, positions of the engine brake capsule and the CDA capsule may be interchangeable (e.g., the CDA capsule may contact the cam.) It should be understood that the examples described above are not exhaustive. Other suitable placement of the engine brake capsule and the CDA capsule are also contemplated by this disclosure and will become apparent to those of skill in the art in light of the following descriptions.

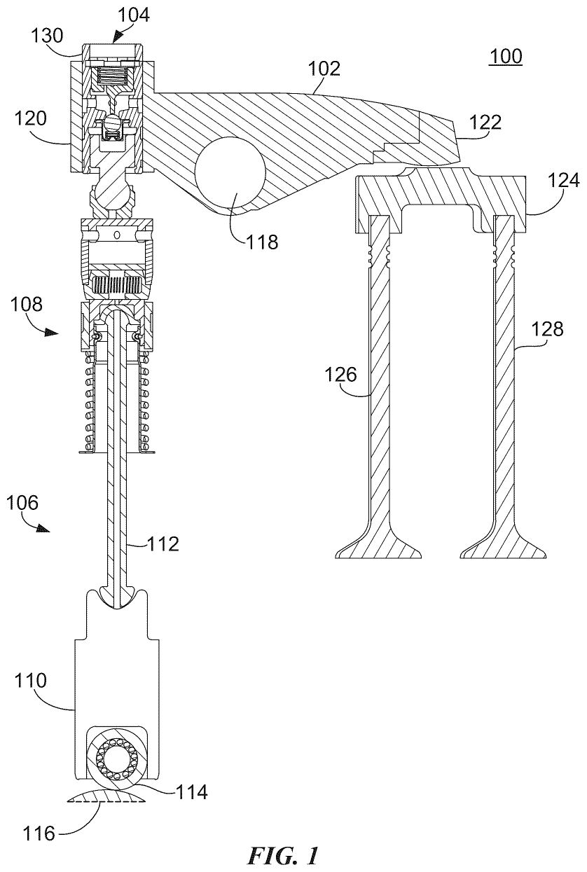

FIG. 1 illustrates an example valve train assembly 100 according to one embodiment of this disclosure. In practice, a pair of valve train assemblies may be provided for each cylinder engine for performing intake and exhaust functions, respectively. For example, an engine brake system may be provided on the exhaust rocker arm, while a CDA system may be provided on the intake and exhaust rocker arms. However, for the sake of simplicity and by way of example only, particular embodiments of this disclosure may be described by referencing one valve train assembly 100 that is, for example, associated with the exhaust side of the engine.

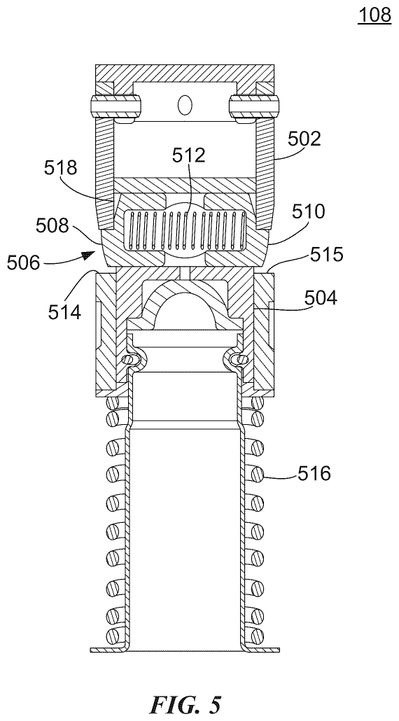

In particular embodiments, the valve train assembly 100 may generally include a rocker arm 102 having an engine brake capsule 104 embedded within and integrated with the rocker arm 102 for performing engine braking and a lifter assembly 106 having a CDA capsule 108 for CDA functionality. For example, in particular embodiments, the lifter assembly 106 may include a lifter 110, a push rod 112, and the CDA capsule 108. The lifter 110 may ride, for example, at a roller bearing 114 thereof, on a cam 116 (partially shown) and is configured to reciprocate in a vertical direction upon actuation by rotation of the cam 116. Upper portion of the lifter 110 may be coupled to a lower end of the push rod 112, while an upper end of the push rod 112 may in turn engage with the CDA capsule 108. As illustrated, the CDA capsule 108 may be operatively coupled to the rocker arm 102—for example, via the engine brake capsule 104 of the rocker arm 102—and configured to selectively transfer cam lift to the rocker arm 102, details of which will be described below with reference to FIG. 5, for example.

In particular embodiments, the rocker arm 102 may be pivotably supported by a rocker shaft (not shown) extending through an opening 118 of the rocker arm 102 such that the rocker arm 102 may rotate around the rocker shaft based on rotation of the cam 116. Specifically, in particular embodiments, a cam end 120 of the rocker arm 102 that is in proximity to the cam 116 may be configured to be operatively coupled to the cam 116 via the lifter assembly 106 for selectively receiving actuation motion. A valve end 122 opposite the cam end 120 of the rocker arm 102 may be configured to be coupled to a valve bridge 124 to transfer motion from the cam 116 to one or more engine valves (e.g., valves 126 and 128) coupled to the valve bridge 124.

In particular embodiment, the cam 116 may have multiple lobes such as a main lift lobe and one or more brake lobes. As an example and not by way of limitation, the main lift lobe may open and close the valves in drive mode. The brake lobes such as for brake gas recirculation (BGR) and compression release (CR) may be smaller than the main lift lobe. The BGR and CR lobes may be configured to open the exhaust valves during engine brake function. In drive mode, the exhaust valves may follow the cam main lift profile, and the BGR and CR profiles may not be transmitted to the valves. In brake mode, the BGR and CR lift profiles may be transmitted to the valves.

It may be desirable to configure the rocker arm 102 to be selectively switchable such that one can choose whether to activate engine brake functionality or not. That is, the rocker arm 102 may transfer between the drive mode (e.g., the rocker arm 102 is in lost motion state, thus the valves 126, 128 remain unactuated regardless of cam rotation during the BGR and CR event) and the engine brake mode (e.g., the rocker arm 102 receives cam lift via the lifter assembly 106 as the cam 116 rotates, delivering actuation motion to the valves 126, 128 for engine braking during BGR and CR events). To this end, in particular embodiments, the engine brake capsule 104 may be provided in the cam end 120 of the rocker arm 102 (e.g., the engine brake capsule 104 is embedded in the cam end 120 of the rocker arm 102). The engine brake capsule 104 may configured to move between a retracted position and an extended position. As an example and not by way of limitation, the engine brake capsule 104 may be controlled hydraulicly by pressurized fluid supplied via a fluid circuit running through the rocker arm 102. In other examples and not by way of limitation, the engine brake capsule 104 may be controlled mechanically, electrically, hydro-mechanically, or in any suitable manner to move between the retracted position and the extended position. In particular embodiments, the engine brake capsule 104 may be received by a vertical bore arranged in the cam end 120 of the rocker arm 102. During operation, portions of the engine brake capsule 104 may be actuated on demand to either protrude outwards from the bottom of the cam end 120 or retract back into the cam end 120.

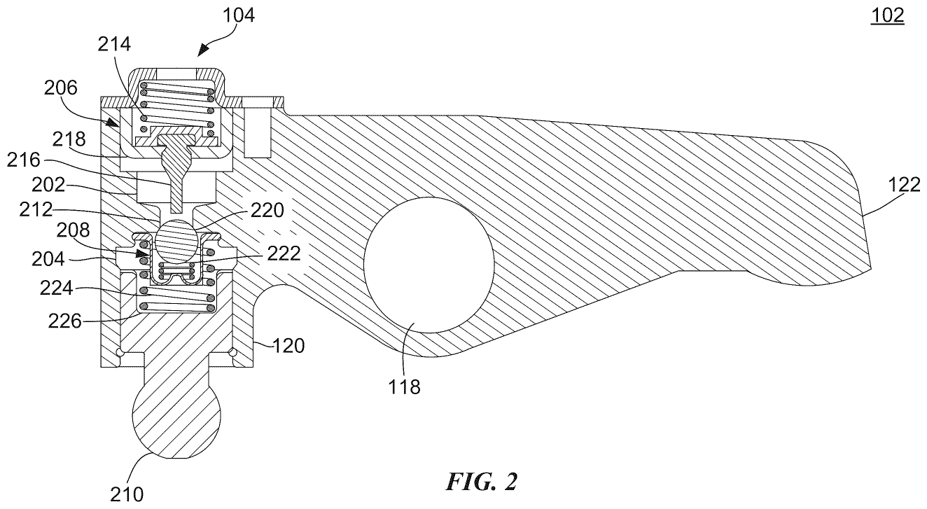

FIG. 2 illustrates a cross-sectional view of the rocker arm 102, specifically showing the engine brake capsule 104 in its extended state. In particular embodiments, components of the engine brake capsule 104 may be assembled directly inside the cam end 120 of the rocker arm 102, such as shown in FIG. 2. This may provide simpler and better packaging, reducing the number and complexity of the capsule components, and consequently reducing assembly cost. To this end, the cam end 120 of the rocker arm 102 may be divided into an upper chamber 202 and a lower chamber 204 for respectively accommodating components of the engine brake capsule 104. As depicted, the upper chamber 202 may house an actuation pin assembly 206. The lower chamber 204 may house a check valve assembly 208 and a plunger 210. Alternatively, in other embodiments such as the one illustrated in FIG. 1, the engine brake capsule 104 may comprise a housing 130, which for example may similarly include an upper chamber and a lower chamber for containing components of the engine brake capsule 104. By containing various capsule components in a single housing, it may allow easier lash adjustment inside the valve train system, and facilitate maintenance, repair, and replacement.

With continued reference to FIG. 2, in particular embodiments, the upper chamber 202 may be ported with one or more fluid channels (not shown). For example, the fluid channels may be arranged circumferentially on a side wall of the upper chamber 202 and configured to receive hydraulic fluid (e.g., oil) with a high pressure that may, for example, be supplied from a fluid control valve to the rocker arm 102. The lower chamber 204 may be positioned below the upper chamber 202 and configured to be in fluid communication with the upper chamber 202 via an opening 212 disposed therebetween. In this way, pressurized fluid introduced into the upper chamber 202 may be allowed to enter via the opening 212 to the lower chamber 204—for example, in a selective way under the control of the check valve assembly 208, details of which will be more clearly explained below.

As further illustrated in FIG. 2, in particular embodiments, the upper chamber 202 may contain the actuation pin assembly 206. The actuation pin assembly 206 may be hydraulicly controlled by fluid pressure introduced in the upper chamber 202 to compress and/or extend vertically. As an example, in the configuration as depicted, a spring 214 may be coupled to an upper end of a pin 216 and configured to bias down the pin 216 to its extended position. As fluid flows in and hydraulic pressure builds up inside the upper chamber 202, the hydraulic force acting on a pin plate 218 coupled to the pin 216 may overcome the downward biasing force applied by the spring 214, consequently pushing the pin 216 in an upward direction into retraction.

In particular embodiments, the check valve assembly 208 located downstream of the actuation pin assembly 206 may be configured to selectively enable fluid communication between the upper chamber 202 and the lower chamber 204 based on the movement of the pin 216. The check valve assembly 208 may be arranged in the lower chamber 204 in a position that is directly below the opening 212. In the embodiment as shown, the check valve assembly 208 comprises a check ball 220, which may be pressed down by the pin 216 in order to open fluid passage through the opening 212. During operation, the check ball 220 may normally press against the opening 212, e.g., by means of a valve spring 222 pushing the check ball 220 upwards. Essentially, in this configuration, the check ball 220 may function as a one-way valve or a non-return valve that allows fluid to flow downwards to the lower chamber 204 but prevents it to flow back in the opposite direction to the upper chamber 202. When the pin 216 moves to its extended position, a lower end of the pin 216 may push against the check ball 220, thereby unseating the check ball 220 from the opening 212 and allowing fluid to flow past the check ball 220 into the lower chamber 204, or vice versa.

In particular embodiments, the lower chamber 204 may further house the plunger 210. For example, the plunger 210 may be disposed below and in line with the check valve assembly 208. Specifically, the plunger 210 may be configured to vertically translate a certain distance in the lower chamber 204 between an extended position and a retracted position upon actuation by the fluid introduced into the lower chamber 204. Explaining further, when the lower chamber 204 is filled with pressurized fluid, the plunger 210 may be hydraulicly actuated in a downward direction to such a position where a lower end of the plunger 210 extends out from the bottom of the cam end 120. In doing so, the plunger 210 may make contact with the lifter assembly 106, thus enabling motion transmission from the cam 116 to the valves 126, 128. In particular embodiments, a lost motion spring 224 may be coupled to the plunger 210, e.g., near an upper end of the plunger 210. For example, the upper end of the plunger 210 may be structured with a spring seat 226 in the form of a cavity, a recess, or the like for supporting the lost motion spring 224 upwards. In operation, the lost motion spring 224 may provide a biasing spring force to the plunger 210. When fluid pressure is removed, the plunger 210 may be free to perform lost motion by means of the lost motion spring 224—e.g., the plunger 210 is free to extend and/or retract, thus absorbing the cam BGR and CR lifts of the cam 116. In other words, by configuring the engine brake capsule 104 in this manner, a variable volume may be formed, which expands and remains expanded when the pressurized fluid reaches the lower chamber 204 through the check valve assembly 208 and pushes the plunger 210 downward, and is retractable when the check valve assembly 208 opens, releasing fluid from the lower chamber 204, in order to enable or disable engine brake functionality.

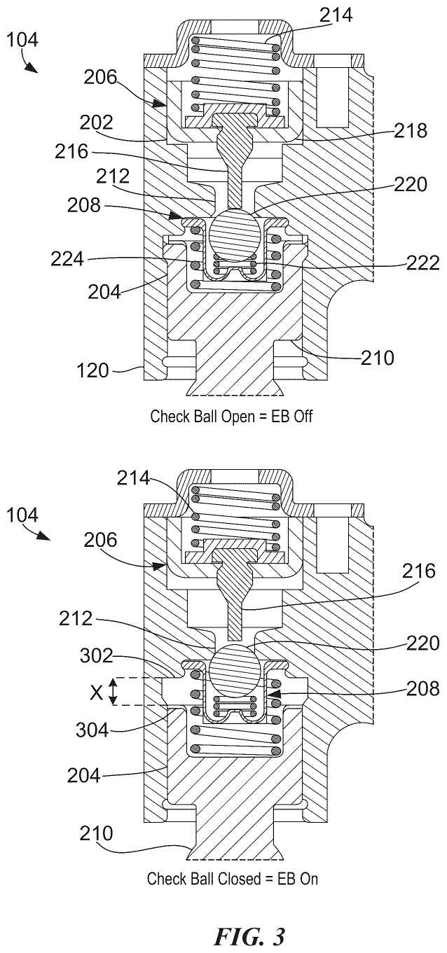

FIG. 3 illustrates an example switching process of the engine brake capsule 104, in which the figure on the top depicts the engine brake capsule 104 in drive mode (e.g., during main exhaust operation), and the figure at the bottom depicts the engine brake capsule 104 in engine brake mode.

During the drive mode of the valvetrain system, the engine brake capsule 104 may be deactivated and remain in its default retractable position where the lower end of the plunger 210 is allowed to retract back into the cam end 120 of the rocker arm 102. For example, in particular embodiments, the lost motion spring 224 may be configured to bias the plunger 210 upward such that any contact between the plunger 210 and the lifter assembly 106 is prevented when the engine brake mode is off. Alternatively, in other embodiments, the lost motion spring 224 may be configured to allow the plunger 210 to contact the lifter assembly 106 and retract up when the lifter assembly 106 moves up, absorbing the brake lift by the cam 116 such that the rocker arm 102 and thus the valves 126, 128 remain unactuated.

When the engine brake functionality is demanded, the engine brake capsule 104 may be activated to its extended state. For example, this may be done hydraulicly, mechanically, electrically, or in other suitable manners. In particular embodiments where hydraulic control is employed, pressurized fluid may enter the upper chamber 202, compressing the spring 214 and pushing the pin 216 upward. Fluid pressure built up in the upper chamber 202 may further push down the check ball 220 of the check valve assembly 208, thus unblocking the opening 212 to allow fluid to enter through the check valve assembly 208 to the lower chamber 204. As the lower chamber 204 is filled with fluid, the plunger 210 may be hydraulicly actuated in the downward direction to its extended position where the lower end of the plunger 210 may protrude out from the bottom of the cam end 120. For example, in the extended position, the upper end 304 of the plunger 210 may be spaced from an upper wall 302 of the lower chamber 204 by a distance X. This distance may also be referred to as a lash.

Afterward, the check valve assembly 208 may be closed and the pressurized fluid may be trapped inside the lower chamber 204 by virtue of the non-return characteristic of the check valve assembly 208 that prevents fluid from flowing back upward. At the same time, the pin 216 may stay retracted and distant from the check ball 220 to guarantee that the check ball 220 remains in its closed position against the opening 212 so that fluid pressure inside the lower chamber 204 is maintained. This is specifically shown by the configuration at the bottom of FIG. 3. In this way, when the lifter assembly 106 is moved up by the cam 116, the extended engine brake capsule 104 may receive and transfer the cam BGR and CR lifts, causing the rocker arm 102 to rotate and thus actuating the valves 126, 128 to perform engine braking based on the cam lift.

When switching back to drive mode or non-brake mode, the system may be depressurized such that the fluid inside the upper chamber 202 may escape, e.g., from a fluid channel. Since the hydraulic pressure is no longer present in the upper chamber 202, the pin 216 may return to its extended position under the downward biasing force applied by the spring 214. In this case, the pin 216 may push down the check ball 220, thus opening the check valve assembly 208. Once opened, the fluid that is previously trapped inside the lower chamber 204 may be released out through the opening 212. As such, since the hydraulic force is removed, the plunger 210 is allowed to retract and closing the lash X, thus absorbing the cam BGR and CR lifts such that the rocker arm 102 does not rotate even if the lifter assembly 106 reciprocates.

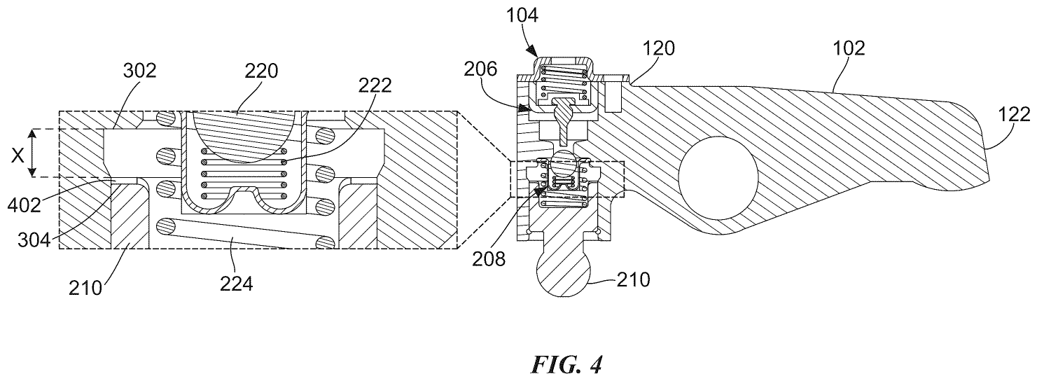

FIG. 4 illustrates the engine brake capsule 104 in more detail. In particular embodiments, the engine brake capsule 104 may also include a shim 402, which may be useful for lash setting. As an example and not by way of limitation, the shim 402 may be generally circular and positioned on top of the plunger 210, e.g., coupled to the upper end 304 of the plunger 210. In operation, when the engine brake function is turned off (for example, in a way as described previously), the plunger 210 may perform lost motion, closing the lash X between the shim 402 and the upper wall 302 of the lower chamber 204. By configuring the shim 402 with a desired size (e.g., height in particular), the lash X may be accurately controlled and easily adjusted depending on needs. In this way, the lash X may have the least variation possible, precisely defining the position or travel distance of the plunger 210 and avoiding affecting the valve lift variation significantly. In particular embodiments, the shim 402 may be formed as an O-ring, a washer, a spacer, or other suitable stiff structures for performing the desired function of this disclosure. Although this disclosure describes an engine brake capsule with a particular shim in a particular manner, this disclosure contemplates with engine brake capsules with any suitable shims in any suitable manner. In particular embodiments, the valve end 122 of the rocker arm 102 and the valve bridge 124 may need to maintain a pre-determined gap distance. Such gap distance may be based on the system model and configurations. To control this gap distance, the engine brake capsule 104 may use the shim 402 with a customized thickness depending on the system model and configuration to control the gap between the valve end 122 of the rocker arm 102 and the valve bridge 124. By using this shim 402 with a customized thickness, the system may customize the gap distance between the valve end 122 of the rocker arm 102 and the valve bridge 124 with no need to change other components of the system, reducing the complexity and cost related to manufacturing and assembling.

FIG. 5 illustrates, in cross section, an embodiment of the CDA capsule 108 of the lifter assembly 106. In particular embodiments, the CDA capsule 108 may be configured for providing so-called CDA functionalities, i.e., a chosen combination of cylinders is systematically disabled, for example, for better fuel economy or overall engine efficiency such that the system may operate on fewer cylinders when less power output is demanded. To this end, the CDA capsule 108 may be provided with various switching components to selectively enable and/or disable motion transfer from the cam 116 to the rocker arm 102. As an example and not by way of limitation, the switching components may mechanically or hydraulicly switch the CDA capsule 108 between a latched mode for cylinder activation and an unlatched mode for cylinder deactivation.

In particular embodiments, the CDA capsule 108 may comprise an outer body 502 and an inner body 504 positioned inside the outer body 502 and configured to be able to travel vertically relative to the outer body 502 as demanded. For example, the inner body 504 may comprise a collapsible latching mechanism 506 that is housed in a chamber 518 of the inner body 504 and designed to switch between a latched position and an unlatched position. As an example and not by way of limitation, the latching mechanism 506 may include one or more latch pins such as two latch pins 508, 510, and a spring 512 connected therebetween. In operation, the inner body 504 may be fixed relative to the outer body 502 in the default latched position where a biasing force applied by the spring 512 may push the two latch pins 508, 510 outwards into engagement with one or more slots 514, 515 of the outer body 502. Such latched configuration is depicted in FIG. 5. When this happens, the inner body 504 is locked tight with the outer body 502 by the latching mechanism 506 in the extended state, thus enabling motion transmission through the CDA capsule 108 to activate the associated engine cylinder.

Conversely, for example, when cylinder deactivation is needed, the latch pins 508, 510 may be compressed—for example, by hydraulic pressure communicated to the chamber 518 of the inner body 504—to an extent that the latch pins 508, 510 retract out of engagement from the slots 514, 515 while the spring 512 is pressed by the hydraulic pressure applied through the latch pins 508 and 510. In this case, the inner body 504 is released and free to translate along the vertical direction inside the outer body 502 such that any actuation motion applied via the cam 116 may be absorbed by the up-and-down displacement between the inner body 504 and the outer body 502. In some embodiments, a lost motion spring 516 may be coupled to the CDA capsule 108 to dampen the relative movement of the inner body 504 and the outer body 502. When switching back to lift mode, hydraulic pressure supply to the inner body 504 may be cut off, and the spring 512 may again bias the two latch pins 508, 510 outwards into the slots 514, 515 to return to the latched position.

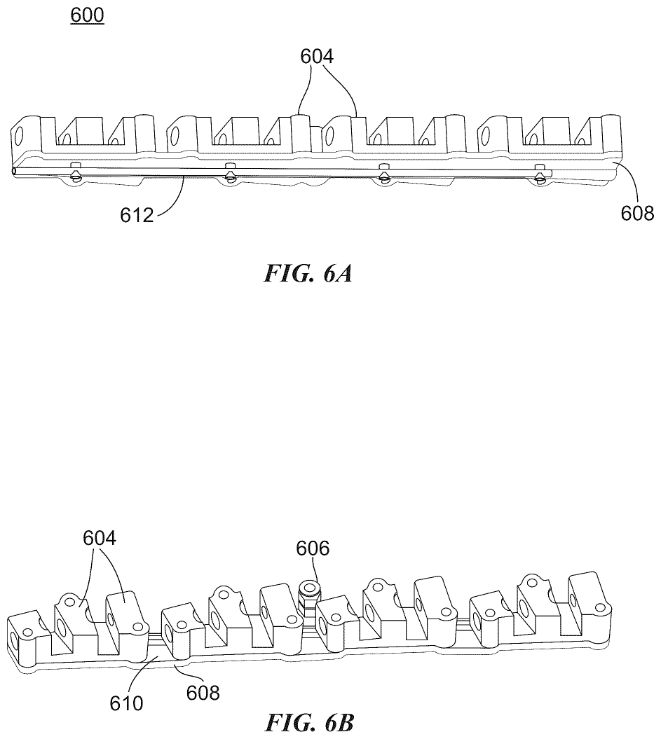

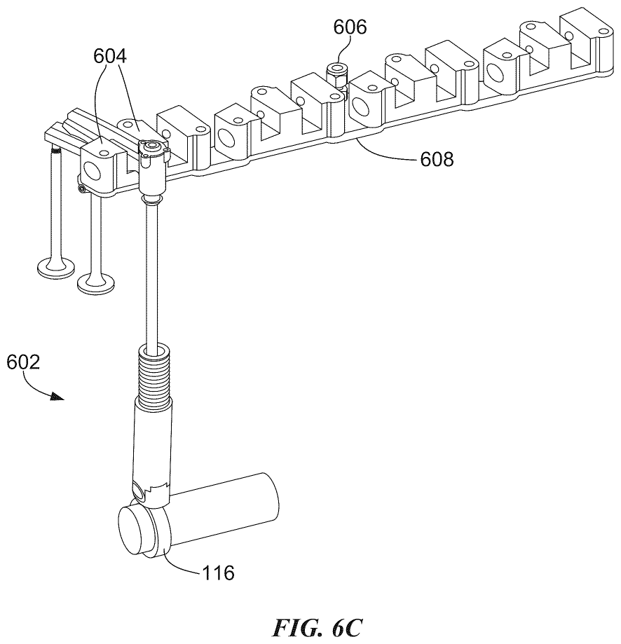

FIGS. 6A-6C illustrate an example carrier assembly 600, which may be used in connection with a valve train assembly 602 according to this disclosure. In particular embodiments, the carrier assembly 600 may generally include multiple carriers 604, a fluid inlet 606, a base plate 608, and optionally a sealing plate 610. For example, the valve train assembly 602, which may be similar to the embodiment of the valve train assembly 100 described above, may be supported between the carriers 604, as depicted in FIG. 6C. The base plate 608 may be located below and connect the carriers 604 and may be configured with one or more fluid galleries 612. As an example and not by way of limitation, the fluid galleries 612 may be drilled, milled, or otherwise manufactured in the base plate 608. Optionally, in some embodiments, the sealing plate 610 may be provided on top of the base plate 608 for better protection against fluid leakage.

In particular embodiments, the fluid galleries 612 of the base plate 608 may be fluidly connected to the fluid inlet 606 and the valve train assembly 602 for enabling hydraulic communication between the fluid inlet 606 and the valve train assembly 602, e.g., to control operation of components of the valve train assembly 602 such as an engine brake capsule. For example, hydraulic fluid passages may be located in the engine block compartment where the CDA capsule travels in a linear position. In particular embodiments, the fluid inlet 606 may be coupled to a fluid control valve (not shown) that is configured as a fluid source. Configured as such, a single fluid control valve may be used for supplying fluid to multiple carriers 604. In other words, it may eliminate the need to provide a separate fluid control valve for each carrier for fluid actuation. By using the base plate 608 to limit the amount of fluid control valves, overall cost of the valve train system may be significantly reduced. This also simplifies packaging as the fluid control valve may be packaged anywhere possible and fluid may then be distributed by the base plate 608.

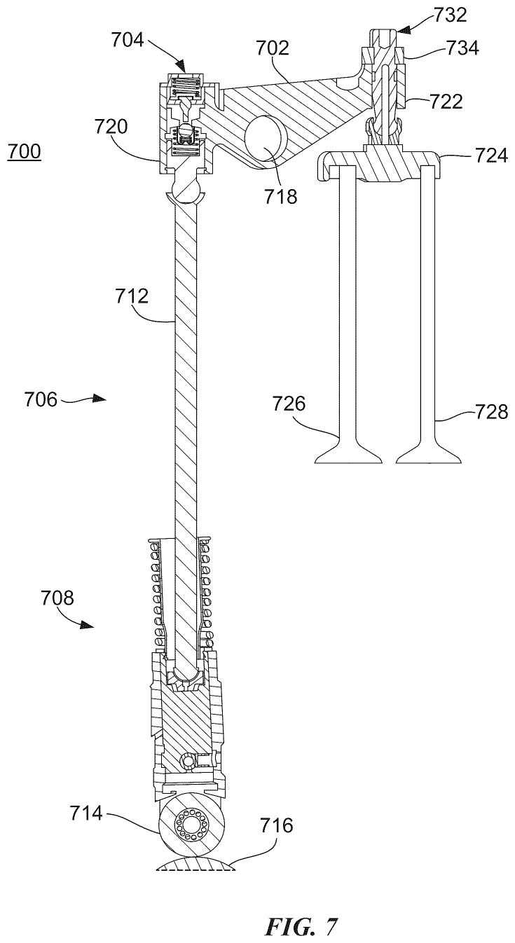

FIG. 7 illustrates another embodiment of a valve train assembly 700. The valve train assembly 700 may generally be similar to the embodiment of the valve train assembly 100 described above. For example, in particular embodiments, the valve train assembly 700 may generally include a rocker arm 702 having an engine brake capsule 704 for performing engine braking and a lifter assembly 706 having a CDA capsule 708 for CDA functionality. As illustrated, the lifter assembly 706 may include a push rod 712 and the CDA capsule 708. As illustrated, the CDA capsule 708 may include or be coupled to a roller bearing 714 at its bottom, which may ride on a cam 716 (partially shown). The CDA capsule 708 may generally be similar to the embodiment of the CDA capsule 108 described above. For example, the CDA capsule 708 may be configured to selectively reciprocate in a vertical direction upon actuation by rotation of the cam 716. Upper portion of the CDA capsule 708 may be coupled to a lower end of the push rod 712, while an upper end of the push rod 712 may in turn engage with the rocker arm 702—for example, via the engine brake capsule 704 of the rocker arm 702—to transfer cam lift to the rocker arm 702 as needed.

In particular embodiments, the rocker arm 702 may be pivotably supported by a rocker shaft (not shown) extending through an opening 718 of the rocker arm 702 such that the rocker arm 702 may rotate around the rocker shaft based on rotation of the cam 716. Specifically, in particular embodiments, a cam end 720 of the rocker arm 702 that is in proximity to the cam 716 may be configured to be operatively coupled to the cam 716 via the lifter assembly 706 for selectively receiving actuation motion. A valve end 722 opposite the cam end 720 of the rocker arm 702 may be configured to be coupled to a valve bridge 724 to transfer motion from the cam 716 to one or more engine valves (e.g., valves 726 and 726) coupled to the valve bridge 724.

Additionally, the valve end 722 of the rocker arm 702 may include an elephant foot (E-foot) assembly 732. As an example and not by way of limitation, the E-foot assembly 730 may be received inside a vertical bore at the valve end 722 of the rocker arm 702 and configured to engage the valve bridge 724 for transferring valve lift. In particular embodiments, the E-foot assembly 732 may include a lash regulating screw 734, for example, at an upper end of the E-foot assembly 732 for lash setting—i.e., for adjusting the extent of protrusion of the E-foot assembly 732 out of the valve end 722 of the rocker arm 702. It should be noted that although this disclosure describes a valve train assembly with a particular rocker arm having a particular valve end configuration in a particular manner, this disclosure contemplates valve train assemblies with any suitable rocker arms having any suitable valve end configurations in any suitable manner.

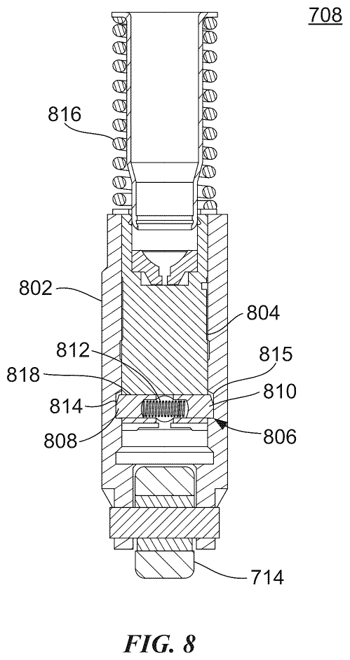

FIG. 8 illustrates a cross-sectional view of the CDA capsule 708 from a different angle. As illustrated, the CDA capsule 708 may be coupled to the push rod 712 at an upper end of the CDA capsule 708. A lower end of the CDA capsule 708 may include or be coupled to the roller bearing 714, which may ride on the cam 716. In particular embodiments, the CDA capsule 708 may be provided with various switching components to selectively enable and/or disable motion transfer from the cam 716 to the rocker arm 702. As an example and not by way of limitation, the switching components may mechanically or hydraulicly switch the CDA capsule 708 between a latched mode for cylinder activation and an unlatched mode for cylinder deactivation.

In particular embodiments, the CDA capsule 708 may comprise an outer body 802 and an inner body 804 positioned inside the outer body 802 and configured to be able to travel vertically relative to the outer body 802 as demanded. For example, the inner body 804 may comprise a collapsible latching mechanism 806 that is housed in a chamber 818 of the inner body 804 and designed to switch between a latched position and an unlatched position. As an example and not by way of limitation, the latching mechanism 806 may include one or more latch pins such as two latch pins 808, 810, and a spring 812 connected therebetween. In operation, the inner body 804 may be fixed relative to the outer body 802 in the default latched position where a biasing force applied by the spring 812 may push the two latch pins 808, 810 outwards into engagement with one or more slots 814, 815 of the outer body 802. Such latched configuration is depicted in FIG. 8. When this happens, the inner body 804 is locked tight with the outer body 802 by the latch mechanism 806 in the extended state, thus enabling motion transmission through the CDA capsule 708 to activate the associated engine cylinder.

Conversely, for example, when cylinder deactivation is needed, the latch pins 808, 810 may be compressed—for example, by hydraulic pressure communicated to the chamber 818 of the inner body 804—to an extent that the latch pins 808, 810 retract out of engagement from the slots 814, 815. In this case, the inner body 804 is released and free to translate along the vertical direction inside the outer body 802 such that any actuation motion applied via the cam 716 may be absorbed by the up-and-down displacement between the inner body 804 and the outer body 802. In some embodiments, a lost motion spring 816 may be coupled to the CDA capsule 708 to dampen the relative movement of the inner body 804 and the outer body 802. When switching back to lift mode, hydraulic pressure supply to the inner body 804 may be cut off, and the spring 812 may again bias the two latch pins 808, 810 outwards into the slots 814, 815 to return to the latched position.

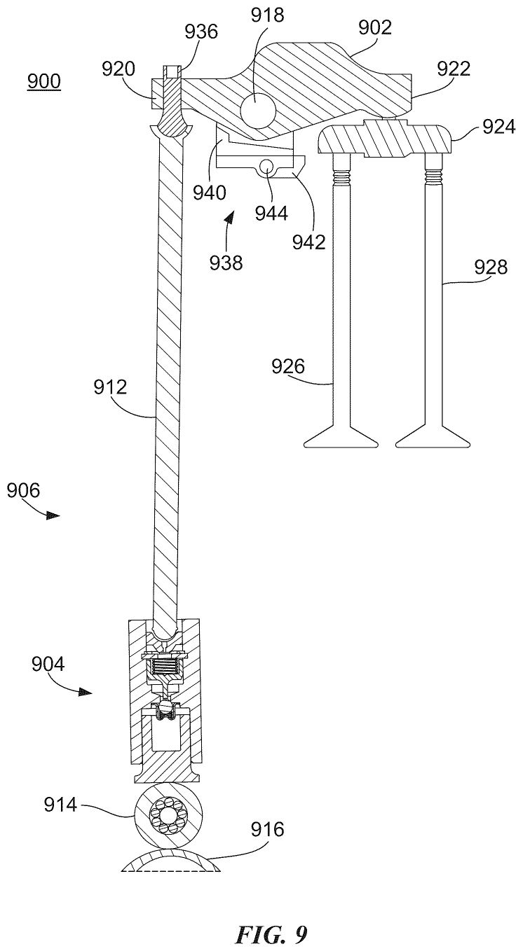

FIG. 9 illustrates yet another embodiment of a valve train assembly 900. The valve train assembly 900 may generally be similar to the embodiment of the valve train assembly 100 described above. For example, in particular embodiments, the valve train assembly 900 may generally include a rocker arm 902 and a lifter assembly 906. As illustrated, the lifter assembly 906 may include a push rod 912 and an engine brake capsule 904. The engine brake capsule 904 may include or be coupled to a roller bearing 914 at its bottom, which may ride on a cam 916 (partially shown). For example, the engine brake capsule 904 may be configured to selectively reciprocate in a vertical direction upon actuation by rotation of the cam 916. Upper portion of the engine brake capsule 904 may be coupled to a lower end of the push rod 912, while an upper end of the push rod 912 may in turn engage with the rocker arm 902—for example, via a lash setting assembly 936 of the rocker arm 902—to transfer cam lift to the rocker arm 902 as needed. Although not shown, in particular embodiments, a CDA capsule may be provided, which may be similar to the ones described above. For example, the CDA capsule may be connected between the engine brake capsule 904 and the push rod 912. Alternatively, the positions of the CDA capsule and the engine brake capsule 904 may be interchangeable such that the CDA capsule contacts the cam 916 and the engine brake capsule 904 is placed above the CDA capsule.

In particular embodiments, the rocker arm 902 may be pivotably supported by a rocker shaft (not shown) extending through an opening 918 of the rocker arm 902 such that the rocker arm 902 may rotate around the rocker shaft based on rotation of the cam 916. As illustrated, the rocker arm 902 may be supported by a carrier assembly 938, which may be similar to the embodiment of the carrier assembly 600 described above. For example, the carrier assembly 938 may generally include multiple carriers 940, a fluid inlet (not shown), and a base plate 942 provided with one or more fluid galleries 944. In particular embodiments, a cam end 920 of the rocker arm 902 that is in proximity to the cam 916 may be configured to be operatively coupled to the cam 916 via the lifter assembly 906 for selectively receiving actuation motion. A valve end 922 opposite the cam end 920 of the rocker arm 902 may be configured to be coupled to a valve bridge 924 to transfer motion from the cam 916 to one or more engine valves (e.g., valves 926 and 928) coupled to the valve bridge 924.

Additionally, the cam end 920 of the rocker arm 902 may include the lash setting assembly 936. As an example and not by way of limitation, the lash setting assembly 936 may be received inside a vertical bore at the cam end 920 of the rocker arm 902 and configured to engage the lifter assembly 906 (or the push rod 912 to be specific) for transferring valve lift. In particular embodiments, the lash setting assembly 936 may be configured in a way such that the extent of protrusion of the lash setting assembly 936 out of the cam end 920 of the rocker arm 902 may be adjusted (e.g., via screw or the like). It should be noted that although this disclosure describes a valve train assembly with a particular rocker arm having a particular cam end configuration in a particular manner, this disclosure contemplates valve train assemblies with any suitable rocker arms having any suitable cam end configurations in any suitable manner.

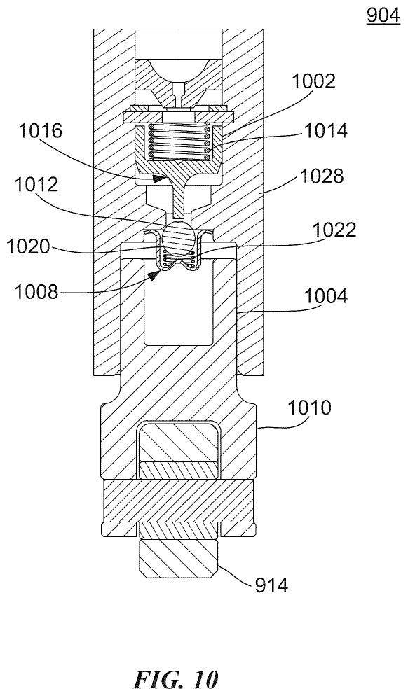

FIG. 10 illustrates a cross-sectional view of the engine brake capsule 904 from a different angle. In particular embodiments, the engine brake capsule 904 may be particularly designed to perform engine braking. For example, the engine brake capsule 904 may include various components of an engine brake capsule, such as the engine brake capsule 104, 704 described above. Although not shown, in particular embodiments, a CDA capsule may be provided, which may be similar to the ones described above. For example, the CDA capsule may be embedded or integrated in the cam end of the rocker arm in a way similar to the engine brake capsule 104 described above or in any other suitable manner. The CDA capsule may be coupled to the engine brake capsule 904 via a push rod, such as push rod 912.

In particular embodiments, various components associated with engine braking functionality may be assembled directly inside an outer body 1028 of the engine brake capsule 904. This may provide simpler and better packaging, reducing the number and complexity of the engine braking components, and consequently reducing assembly cost. To this end, the outer body 1028 may be divided into an upper chamber 1002 and a lower chamber 1004 for respectively accommodating components for engine brake. As depicted, the upper chamber 1002 may house a pin 1016. The lower chamber 1004 may house a check valve assembly 1008 and a plunger 1010.

With continued reference to FIG. 10, in particular embodiments, the upper chamber 1002 may be ported with one or more fluid channels (not shown). For example, the fluid channels may be arranged circumferentially on a side wall of the upper chamber 1002 and configured to receive hydraulic fluid (e.g., oil). The lower chamber 1004 may be positioned below the upper chamber 1002 and configured to be in fluid communication with the upper chamber 1002 via an opening 1012 disposed therebetween. In this way, pressurized fluid introduced into the upper chamber 1002 may be allowed to enter via the opening 1012 to the lower chamber 1004—for example, in a selective way under the control of the check valve assembly 1008, details of which will be more clearly explained below.

As further illustrated in FIG. 10, in particular embodiments, the upper chamber 1002 may contain the pin 1016. The pin 1016 may be hydraulicly controlled by fluid pressure introduced in the upper chamber 1002 to compress and/or extend vertically. As an example, in the configuration as depicted, a spring 1014 may be coupled to an upper end of the pin 1016 and configured to bias down the pin 1016 to its extended position. As fluid flows in and hydraulic pressure builds up inside the upper chamber 1002, the hydraulic force acting on the pin 1016 may overcome the downward biasing force applied by the spring 1014, consequently pushing the pin 1016 in an upward direction into retraction.

In particular embodiments, the check valve assembly 1008 located downstream of the pin 1016 may be configured to selectively enable fluid communication between the upper chamber 1002 and the lower chamber 1004 based on the movement of the pin 1016. The check valve assembly 1008 may be arranged in the lower chamber 1004 in a position that is directly below the opening 1012. In the embodiment as shown, the check valve assembly 1008 comprises a check ball 1020, which may be pressed down by the pin 1016 in order to open fluid passage through the opening 1012. During operation, the check ball 1020 may normally press against the opening 1012, e.g., by means of a valve spring 1022 urging the check ball 1020 upwards. Essentially, in this configuration, the check ball 1020 may function as a one-way valve or a non-return valve that allows fluid to flow downwards to the lower chamber 1004 but prevents it to flow back in the opposite direction to the upper chamber 1002. When the pin 1016 moves to its extended position, a lower end of the pin 1016 may push against the check ball 1020, thereby unseating the check ball 1020 from the opening 1012 and allowing fluid to flow past the check ball 1020 into the lower chamber 1004, or vice versa.

In particular embodiments, the lower chamber 1004 may further house the plunger 1010. For example, the plunger 1010 may be disposed below and in line with the check valve assembly 1008. Specifically, the plunger 1010 may be configured to vertically translate a certain distance in the lower chamber 1004 between an extended position and a retracted position upon actuation by the fluid introduced into the lower chamber 1004. Explaining further, when the lower chamber 1004 is filled with pressurized fluid, the plunger 1010 may be hydraulicly actuated in a downward direction to such a position where a lower end of the plunger 1010 extends out from the bottom of the outer body 1028. In doing so, the plunger 1010 may make contact with the cam 916, thus enabling motion transmission from the cam 916 to the valves 926, 928. To achieve this, for example, the lower end of the plunger 1010 may include or be coupled to the roller bearing 914, which may ride on the cam 916. When fluid pressure is removed, the plunger 1010 may be free to perform lost motion—e.g., the plunger 1010 is free to extend and/or retract, thus absorbing the cam lift of the cam 916. In other words, by configuring the engine brake capsule 904 in this manner, a variable volume may be formed, which expands and remains expanded when the pressurized fluid reaches the lower chamber 1004 through the check valve assembly 1008 and pushes the plunger 1010 downward, and is retractable when the check valve assembly 1008 opens, releasing fluid from the lower chamber 1004, in order to enable or disable engine brake functionality.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A valve train assembly, comprising:
a rocker arm having a cam end in proximity to a cam and a valve end opposite to the cam end and in proximity to one or more valves;
an engine brake capsule coupled to the cam end and comprising an actuation pin assembly, a check valve assembly, and a plunger, the engine brake capsule being configured to switch between a retracted position and an extended position; and
a cylinder deactivation capsule coupled to the cam end and comprising an outer body, an inner body, and a latching mechanism, the cylinder deactivation capsule being configured to switch between a latched position and an unlatched position.

2. The valve train assembly of claim 1, wherein when the engine brake capsule is configured to switch to the extended position and the cylinder deactivation capsule is configured to switch to the latched position, the rocker arm is allowed to be actuated based on a brake lift profile of the cam.

3. The valve train assembly of claim 1, wherein when the engine brake capsule is configured to switch to the retracted position and the cylinder deactivation capsule is configured to switch to the latched position, the rocker arm is allowed to be actuated based on a main lift profile of the cam.

4. The valve train assembly of claim 1, wherein when the cylinder deactivation capsule is configured to switch to the unlatched position, the rocker arm is unactuated despite rotation of the cam.

5. The valve train assembly of claim 1, wherein the cylinder deactivation capsule is directly coupled to the engine brake capsule.

6. The valve train assembly of claim 1, wherein the cylinder deactivation capsule is coupled to the engine brake capsule via a push rod.

7. The valve train assembly of claim 1, wherein the cylinder deactivation capsule is coupled to the engine brake capsule, and wherein the engine brake capsule is coupled to the cam end of the rocker arm via a push rod.

8. The valve train assembly of claim 1, wherein the cylinder deactivation capsule is coupled to the engine brake capsule, and wherein the cylinder deactivation capsule is coupled to the cam end of the rocker arm via a push rod.

9. The valve train assembly of claim 1, wherein the engine brake capsule is at least partially embedded in the cam end of the rocker arm.

10. The valve train assembly of claim 1, wherein the cylinder deactivation capsule is at least partially embedded in the cam end of the rocker arm.

11. The valve train assembly of claim 1, wherein the check valve assembly comprises a ball and a valve spring.

12. The valve train assembly of claim 11, wherein the valve spring is configured to bias the ball upward to close an opening in the engine brake capsule.

13. The valve train assembly of claim 1, wherein in the retracted position of the engine brake capsule, the plunger is configured to be retractable relative to the cam end to absorb a brake lift profile of the cam.

14. The valve train assembly of claim 1, wherein in the extended position of the engine brake capsule, the plunger is configured to remain extended relative to the cam end to transmit motion applied by a brake lift profile of the cam.

15. The valve train assembly of claim 1, wherein an upper end of the plunger is configured with a shim.

16. The valve train assembly of claim 1, wherein the latching mechanism comprises one or more latch pins and a spring.

17. The valve train assembly of claim 1, wherein in the unlatched position of the cylinder deactivation capsule, the cylinder deactivation capsule is configured to absorb motion applied by the cam.

18. The valve train assembly of claim 1, wherein in the latched position of the cylinder deactivation capsule, the cylinder deactivation capsule is configured to allow motion applied by the cam to be transferred to the plunger of the engine brake capsule.

19. The valve train assembly of claim 1, further comprising a carrier assembly to support the rocker arm.

20. The valve train assembly of claim 19, wherein the carrier assembly comprises a plurality of carriers for supporting the rocker arm, a base plate for supporting the plurality of carriers, and a fluid inlet in fluid communication with the base plate.
